(19) United States
(12) Patent Application Publication
(10) Pub. No.: US 2016/0219921 A1
(43) Pub. Date: Aug. 4, 2016

(54) SUPER FOOD BEVERAGE

(71) Applicant: Natalja Klein, Coral Springs, FL (US)

(72) Inventor: Natalja Klein, Coral Springs, FL (US)

(21) Appl. No.: 15/015,419

(22) Filed: Feb. 4, 2016

Related U.S. Application Data
(60) Provisional application No. 62/111,816, filed on Feb. 4, 2015.

(51) Int. Cl. A23L 2/60; A23L 2/52

(52) U.S. Cl. CPC A23L 2/60; A23L 2/52; A23V 2002/00

(57) ABSTRACT

A beverage that provides exceptional health benefits includes a mixture of oatmeal and various combinations of other ingredients each of which provides specific health benefits. In several preferred embodiments, the beverage formulation includes ground oatmeal in combination with one or more of the following ingredients: honey, saffron, cardamom, flax seed, as well as any of all types of tea, herbs, spices, nuts, seeds, berries, fruits, vegetables, mushrooms, eggs, milk, coffee, cacao and cocoa.

This Non-Provisional Patent Application is based on Provisional Patent Application Ser. No. 62/111,816 filed on Feb. 4, 2015.

### BACKGROUND OF THE INVENTION

1. Field of the Invention

The present invention relates to a health food beverage product and, more particularly, to a super food beverage containing oatmeal in combination with other healthy ingredients.

2. Discussion of the Related Art

The benefits of oatmeal are well-known. In particular, oats contain antioxidants that reduce risk of cardiovascular disease. Oatmeal contains both soluble fiber and insoluble fiber. The soluble fiber in oatmeal has been shown to decrease low density lipoprotein (LDL) cholesterol (i.e., bad cholesterol) when consumed as part of a low-fat diet. Oatmeal has also been shown to prevent the arteries from hardening, while stabilizing blood sugar levels and preventing the development of diabetes. Additionally, oatmeal contains a certain type of fiber known as beta-glucan fiber that reduces the likelihood of heart disease while boosting the immune system.

When combined with other healthy food products and spices, oatmeal can provide significant health benefits and protect the body from a vast array of diseases and debilitating conditions. Unfortunately, the regular consumption of oatmeal is not always convenient. To prepare oatmeal, including instant oatmeal, there is a need to boil water either on the stove or in a microwave, and then cook the ground oats, steel oats, rolled oats or an instant oatmeal mixture in the boiling water. The need for preparation in this manner, which requires time and access to appliances such as a stove or microwave, can inhibit or discourage the daily consumption of oatmeal.

There are a variety of healthy and ready to eat products that are available in grocery stores, convenience stores, coffee shops and other venues. For example, yogurt, fruit juices, vegetable juices, protein shakes and energy drinks are readily available for convenient purchase and consumption directly from their containers or packaging. Because these products are healthy and conveniently available for ready consumption, even while on-the-go, they are extremely popular in the consumer market.

Considering the significant health benefits of daily consumption of oatmeal, along with other healthy ingredients, and the high demand for “ready to consume” food products, there exists an urgent need for an oatmeal beverage that can be packaged in bottles, cartons, cans or other containers for ready consumption without the need of any additional preparation or appliances.

### DETAILED DESCRIPTION OF THE INVENTION

The present invention is directed to a super food beverage that contains oatmeal in combination with other healthy ingredients that may include all types of: teas, herbs, nuts, spices, seeds, honey and/or other natural sweeteners, berries, fruits, vegetables, mushrooms, eggs, milk, coffee, cacao and cocoa (chocolate). The super food beverage may be referred to as “Oatmeal-Tum.”

Example formulations of the super food beverage (Oatmeal-Tum) of the present invention include the following:

### EXAMPLE 1

Ground oatmeal
Water (distilled)
Stevia sweetener
Flax seed
Saffron
Cardamom

### EXAMPLE 2

Ground oatmeal (i.e., without fibers)
Water
Honey
Cardamom
Saffron

### EXAMPLE 3

Ground oatmeal
Water
Raisin or prune
Cardamom

### EXAMPLE 4

Ground oatmeal for diabetics no sugar, no salt
Water
Saffron
Cardamom

### EXAMPLE 5 (Baby Formula)

Ground oatmeal
Dill water for baby
Sugar cane or honey

### EXAMPLE 6

Ground oatmeal
Water
Cinnamon
Honey and stevia

### EXAMPLE 7

Ground oatmeal
Water
Fruits and/or berries
Cinnamon

### EXAMPLE 8

Ground oatmeal
Water
Vegetables and/or berries
Mustard
Coriander
Cumin

### EXAMPLE 9

Ground oatmeal
Water
Eggs
Sea salt
Coriander
Cumin

### EXAMPLE 10

Ground oatmeal (strainer) through strainer
Water
Milk
Honey or stevia or sugar cane or any natural sweetener

In preparation, a suitable volume of water is brought to a boil. The ground oatmeal or oatmeal flakes are added to the boiling water and cooked for approximately 5-7 minutes. The cooked oatmeal is then removed from heat and the other ingredients are added while stirring or blending. For a smoother texture, the oatmeal can be strained through a stainless steel strainer prior to adding other ingredients. Moreover, the oatmeal with the combined ingredients can be placed within a blender or other mixing device to thoroughly blend the oatmeal and other ingredients to a smooth, pourable beverage that can be packaged in bottles, cartons, cans or other containers that are commonly used for packaging ready to consume beverages similar to protein shakes and fruit/vegetable smoothies.

The ingredients of the above examples can also be used to make cookies or pancakes. To do this, any of the above ingredients are mixed, while adding the oatmeal flakes or ground oatmeal and 2-3 teaspoons of flower, along with eggs, sea salt, natural sugar and/or stevia, other ingredients such as raisins or dried cranberries, along with any other fruits, nuts, seeds or vegetables. Next, a mixture of oil and water is used to apply a nonstick coating to a baking pan. The mixed ingredients can then be scooped with a spoon or other utensil and placed on the baking pan to make cookies or pancakes. For baking cookies, the pan is placed in an oven that has been preheated to 325° F. The cookies are then baked for approximately 18-25 minutes or until lightly browned. For cooking pancakes, the pan is heated on a stove over a medium flame. The pancakes are cooked approximately 3-4 minutes on each side.

The present invention has been described in accordance with several preferred and practical examples. However, it is recognized that variations or departures from the disclosed examples of the invention is fully contemplated within the spirit and scope of the invention and, therefor, the invention is not to be limited to the specific examples set forth above.

What is claimed is:

1. A beverage comprising:
oatmeal;
saffron;
cardamom;
flax seed;
natural sweetener; and
water.

2. The beverage as recited in claim 1 further comprising:
one or more of any type of fruits.

3. The beverage as recited in claim 1 further comprising:
one or more of any type of vegetables.

4. The beverage as recited in claim 1 further comprising:
one or more of any type of berries.

5. The beverage as recited in claim 1 further comprising:
one or more of any type of nuts.

6. The beverage as recited in claim 1 further comprising:
one or more of any type of seeds.

7. The beverage as recited in claim 1 further comprising:
one or more of any type of tea.

8. The beverage as recited in claim 1 further comprising:
one or more of any type of herbs.

9. The beverage as recited in claim 1 further comprising:
one or more of any type of spices.

10. The beverage as recited in claim 1 further comprising:
mushrooms.

11. The beverage as recited in claim 1 further comprising:
eggs.

12. The beverage as recited in claim 1 further comprising:
milk.

13. The beverage as recited in claim 1 further comprising:
coffee.

14. The beverage as recited in claim 1 further comprising:
cacao.

15. The beverage as recited in claim 1 further comprising:
cocoa.

16. The beverage as recited in claim 1 wherein the natural sweetener comprises honey.

17. The beverage as recited in claim 1 wherein the natural sweetener comprises stevia.

18. The beverage as recited in claim 1 wherein the natural sweetener comprises sugarcane.
